(19) United States
(12) Patent Application Publication
(10) Pub. No.: US 2004/0251991 A1
(43) Pub. Date: Dec. 16, 2004

(54) Electronically tunable comb-ring type RF filter

(76) Inventors: Mohammed Mahbubur Rahman, Glastonbury, CT (US); Khosro Shamsaifar, Ellicott City, MD (US)

Correspondence Address: James S. Finn, 8650 Southwestern Blvd. #2825, Dallas, TX, 75206-2688, US

(21) Appl. No.: 10/772,653

(22) Filed: Feb. 5, 2004

Related U.S. Application Data
(60) Provisional application No. 60/445,344, filed on Feb. 5, 2003.

(51) Int. Cl. H01P 1/203

(52) U.S. Cl. 333/205

(57) ABSTRACT

A voltage-controlled tunable comb-ring type filter which includes a plurality of resonators and wherein the plurality of resonators include a first of at least two combline type resonators, a first of at least one ring type resonator coupled to the first of at least two combline type resonator, a second of the at least two combline type resonator coupled to the first of at least one ring type resonator and cross coupled to the first of at least two combline type resonators, and at least one of the plurality of resonators includes at least one variable capacitor. An input transmission line is connected with at least one of the plurality of resonators and an output transmission line is connected with at least one of the resonators.

The cross coupling mechanism between the second of the at least two combline type resonators with the first of at least two combline type resonators can be through a transmission line shorted on all ends of the at least two combline type resonators or by placing the first of at least one ring type resonator in a different layer or by keeping all of the at least two combline type resonators relatively straight and placing the first of at least one ring type resonator such that cross coupling occurs between the plurality of resonators by virtue of the proximity of all of the plurality of resonators.

### CROSS-REFERENCE TO RELATED APPLICATION

This application claims priority to U.S. Provisional patent application Ser. No. 60/445,344, “ELECTRONICALLY TUNABLE COMB-RING TYPE RF FILTER” filed Feb. 05, 2003, by Mohammed Mahbubur Rahman et al.

### BACKGROUND OF THE INVENTION

The present invention generally relates to tunable Radio Frequency filters and tunable dielectric capacitors.

Electronically tunable microwave filters have found wide applications in microwave systems. Compared to mechanically and magnetically tunable filters, electronically tunable filters have the most important advantage of fast tuning capability over a wide band application. Because of this advantage, they can be used in applications such as cellular, PCS (personal communication system), Point to Point, Point to multipoint, LMDS (local multipoint distribution service), frequency hopping, satellite communication, and radar systems. Electronically tunable filters can be divided into two types: one is a dielectric capacitor based tunable filter and the other is semiconductor varactor based tunable filter. Compared to the semiconductor varactor based tunable filters, tunable dielectric capacitor based tunable filters have the merits of lower loss, higher power-handling, and higher. IP3, specifically at higher frequencies.

Tunable filters have been developed for radio frequency (RF) applications. They are tuned electronically by using either dielectric varactors or Micro-electro-mechanical systems (MEMS) based varactors. Tunable filters offer service providers flexibility and scalability, which were never possible before. A single tunable filter solution enables radio manufacturers to replace several fixed filters covering adjacent frequencies. This versatility provides front-end RF tunability in real time applications and decreases deployment and maintenance costs through software controls and reduced component count. Also, fixed filters need to be wide band so that the total number of filters to cover a desired frequency range does not exceed reasonable numbers. Tunable filters, however, are narrow band and may be tuned in the field by remote command. Additionally, narrowband filters at the front end are superior from the systems point of view, because they provide better selectivity and help reduce interference from nearby transmitters. Two of such filters can be combined in diplexer or duplexer configurations.

Inherent in every tunable filter is the ability to rapidly tune the response using high-impendance control lines. The assignee of the present invention has developed and patented unable filter technology such as the tunable filter set forth in U.S. Pat. No. 6,525,630 entitled, “Microstrip tunable filters tuned by dielectric varactors”, issued Feb. 25, 2003 by Zhu et al. This patent is incorporated in by reference. Also, patent application Ser. No. 09/457,943, entitled, “ELECTRICALLY TUNABLE FILTERS WITH DIELECTRIC VARACTORS” filed Dec. 9, 1999, by Louise C. Sengupta et al. This application is incorporated in by reference.

The assignee of the present invention and in the patent and patent application incorporated by reference has developed the materials technology that enables these tuning properties, as well as, high Q values resulting low losses and extremely high IP3 characteristics, even at high frequencies. The articulation of the novel tunable material technology is elaborated on in the patent and patent application incorporated in by reference.

Also, tunable filters based on MEMS technology can be used for these applications. They use different bias voltages to vary the electrostatic force between two parallel plates of the varactor and hence change its capacitance value. They show lower Q than dielectric varactors, but can be used successfully for low frequency applications.

Therefore, a strong need in the industry exists for RF filters that can reduce complexity by replacing multiple filters and switch assemblies with a single tunable filter that can tune its center frequency over multiple bands. Ultimately, it is desirable for several of these tunable filters to be integrated into a larger module to produce even further reduction of size.

### SUMMARY OF THE INVENTION

The present invention provides a voltage-controlled tunable comb-ring type filter which includes a plurality of resonators and wherein the plurality of resonators include a first of at least two combline type resonators, a first of at least one ring type resonator coupled to the first of at least two combline type resonator, a second of the at least two combline type resonator coupled to the first of at least one ring type resonator and cross coupled to the first of at least two combline type resonators, and at least one of the plurality of resonators includes at least one variable capacitor. An input transmission line is connected with at least one of the plurality of resonators and an output transmission line is connected with at least one of the resonators.

The cross coupling mechanism between the second of the at least two combline type resonators with the first of at least two combline type resonators can be through a transmission line shorted on all ends of the at least two combline type resonators or by placing the first of at least one ring type resonator in a different layer or by keeping all of the at least two combline type resonators relatively straight and placing the first of at least one ring type resonator such that cross coupling occurs between the plurality of resonators by virtue of the proximity of all of the plurality of resonators.

The present invention can further include biasing lines associated with the variable capacitor to provide bias to the variable capacitors and wherein the biasing lines can include four resistors to block any RF leakage into the DC biasing lines. In a preferred embodiment any or all of the resonators can be implemented in a microstrip or stripline form and any or all of the resonators can be bent towards each other to reduce the size of the filter. A preferred embodiment of the present invention provides a ring resonator circuit with a DC blocking capacitor at the opposite end of the variable capacitor position in order to make the whole structure of the present invention symmetric.

The aforementioned variable capacitor can be a tunable dielectric capacitor with a substrate having a low dielectric constant with planar surfaces and can further comprise a tunable dielectric film on the substrate made from a low loss tunable dielectric material. Also a metallic electrode with predetermined length, width, and gap distance can be associated with at least one resonator. The center frequency of the filter can be tuned by changing the varactor capacitance controlled by changing the voltage applied to the varactor. In addition, the variable capacitor can be a tunable MEMS capacitor.

The present invention also enables a method of filtering signals using a voltage-controlled tunable comb-ring type filter by providing a first resonator, coupling a second resonator to the first resonator, coupling a third resonator to the second resonator and cross coupling the third resonator to the first resonator. The first and third resonators can be combline type resonators and the second resonator can be a ring type resonator in one preferred embodiment.

The method of one embodiment of the present invention can include an input transmission line connected with the first resonator and an output transmission line connected with the third resonator. The cross coupling mechanism between the first resonator and the third resonator can be through a transmission line shorted on both ends, by placing the second resonator in a different layer or by keeping the first resonator and the third resonator relatively straight and placing the second resonator such that cross coupling occurs between the first resonator and the second resonator by virtue of the proximity of all three resonators to each other.

The aforementioned at least one of the resonators can include at least one variable capacitor and the present method provides for the step of providing bias to the variable capacitors by providing biasing lines associated with the variable capacitor and wherein the biasing lines can include four resistors to block any RF leakage into the DC biasing lines.

Any or all of the resonators can be implemented in a microstrip or stripline form and can be bent towards each other to reduce the size of the filter and wherein in any or all of the resonators, DC blocking capacitor can be used at the end of the any or all of the resonators in order to bias any or all of the resonators. The step of providing a ring resonator circuit with a DC blocking capacitor at the opposite end of the variable capacitor position in order to make the whole structure symmetric can be implemented in a preferred embodiment of the present invention. And the variable capacitor can be a tunable dielectric capacitor in the present method. The tunable dielectric capacitor can included a substrate having a low dielectric constant with planar surfaces and the present method can include the step of providing a tunable dielectric film on the substrate made from a low loss tunable dielectric material and further comprising a metallic electrode with predetermined length, width, and gap distance associated with at least one resonator. The present method can include the step of providing a low loss isolation material used to isolate an outer bias metallic contact and the metallic electrode on the tunable dielectric material.

The method of one preferred embodiment provides that the center frequency of the filter can be tuned by changing the varactor capacitance controlled by changing the voltage applied to the varactor.

The present method allows for the variable capacitor to be a tunable MEMS capacitor in a parallel or interdigital plate topology. Also, the present method allows for the variable capacitor to be a tunable semiconductor diode varactor. Lastly, the present method allows for the step of providing a means of inter-resonator coupling between adjacent and non-adjacent resonators in the filters.

### BRIEF DESCRIPTION OF THE DRAWINGS

FIG. 1 depicts the layout of the comb-ring type tunable filter for one embodiment of the present invention;

FIG. 2 graphically illustrates the response of the filter shown in FIG. 1 when tuned with a low voltage;

FIG. 2b graphically illustrates the response of the filter shown in FIG. 1 when tuned with high voltage;

FIG. 3 depicts the layout of the comb-ring type tunable filter for a second embodiment of the present invention;

FIG. 4 graphically illustrates the response of the filter shown in FIG. 3 when tuned with a low voltage;

FIG. 4B graphically illustrates the response of the filter shown in FIG. 3 when tuned with high voltage;

FIG. 5 depicts the layout of the comb-ring type tunable filter for a third embodiment of the present invention;

FIG. 6 graphically illustrates the response of the filter shown in FIG. 5 when tuned with a low voltage;

FIG. 6B graphically illustrates the response of the filter shown in FIG. 5 when tuned with high voltage;

### DESCRIPTION OF THE PREFERRED EMBODIMENT

It is an object of the present invention to provide a voltage-tuned filter having very small size, low insertion loss, fast tuning speed, high power-handling capability, high IP3 and low cost in the RF and microwave frequency range. Compared to voltage-controlled semiconductor varactors, voltage-controlled tunable dielectric capacitors have higher Q factors, higher power-handling capability and higher third order intercept point (IP3). Voltage-controlled tunable diode varactors or voltage controlled MEMS varactors can also be employed in the filter structure, although with worse performance. The present invention is a tunable RF filter with asymmetric response. The tuning elements can be voltage-controlled tunable dielectric capacitors or MEMS varactors placed on the resonator lines of each filter. Since the tunable dielectric capacitors show high Q, and high IP3 (low inter- modulation distortion), the tunable filter in the present invention has the advantage of low insertion loss, and high power handling. It is also low cost and provides fast tuning. The present technology makes tunable filters very promising in the contemporary communication system applications.

The tunable dielectric capacitor in the present invention is made from low loss tunable dielectric film. The range of Q-factor of the tunable dielectric capacitor is between 50, for very high tuning material, and 300, for low tuning materials. It decreases with the increase of the frequency, but even at higher frequencies, say 30 GHz, can have values as high as 100. A wide range of capacitance of the tunable dielectric capacitors is available; say 0.1 pF to several pF. The tunable dielectric capacitor is a packaged two-port component, in which tunable dielectric can be voltage-controlled. The tunable film is deposited on a substrate, such as MgO, LaAIO3, sapphire, Aha3 and other dielectric substrates. An applied voltage produces an electric field across the tunable dielectric, which produces an overall change in the capacitance of the tunable dielectric capacitor.

The tunable capacitors based on MEMS technology can also be used in the tunable filter and are part of this invention. At least two varactor topologies can be used, parallel plate and interdigital. In a parallel plate structure, one of the plates is suspended at a distance from the other plate by suspension springs. This distance can vary in response to electrostatic force between two parallel plates induced by applied bias voltage. In the interdigital configuration, the effective area of the capacitor is varied by moving the fingers comprising the capacitor in and out and changing its capacitance value. MEMS varactors have lower Q than their dielectric counterpart, especially at higher frequencies, but can be used in low frequency applications. Although not depicted in the figures of the present invention, MEMS varactors can replace the dielectric capacitors by methods known to those of ordinary skill in the art of MEMS varactor and RF filter technology.

The tunable filter in the present invention has asymmetric frequency response and a preferred embodiment consists of three resonators with a cross coupling mechanism between two non-adjacent resonators to provide a transmission zero on one side of the filter pass band. The filter can be implemented in microstrip or strip line form, however, it is understood that other implementations are possible.

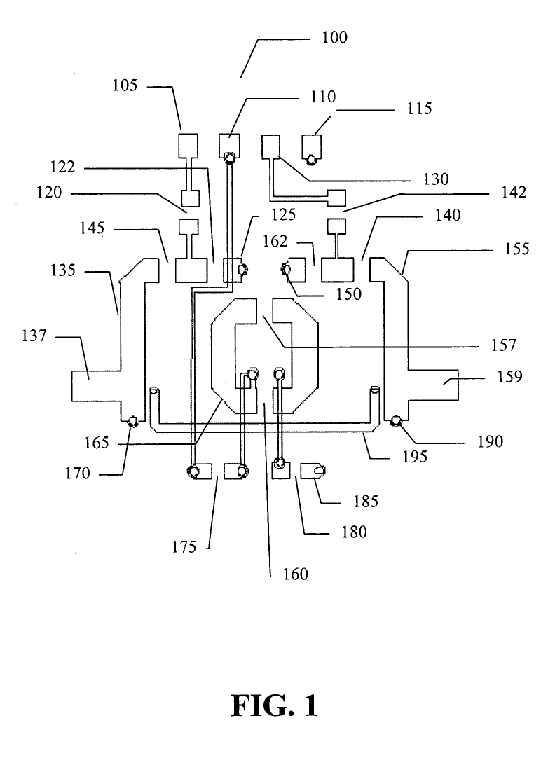

The various features of the present invention will now be described with respect to the figures. The present invention is a tunable comb-ring type filter and will be described herein in three distinct embodiments. The main difference among the three embodiments is the mechanism of the cross coupling. The filter layout of the first embodiment is illustrated in FIG. 1. The filter consists of two combline resonators, and one ring resonator. The combline resonators are bent towards each other to reduce the size of the filter. This particular filter is intended for the application where more selectivity is required in the low side of the pass band. Therefore, asymmetric filter response is desired and it is implemented by providing cross coupling between the two end combline resonators. The cross coupling in the first embodiment of FIG. 1 is realized by a transmission line shorted on both end. The cross coupling between the end resonators create a transmission zero. Either cross-coupling value or the coupling line length determines the position of the transmission zero. To make the filter tunable, a varactor is placed on each resonator at the positions shown in FIG. 1. A DC blocking capacitor is used in each resonator in order to bias the varactors.

In case of the combline resonators, the DC blocking capacitors are used at the end of the resonators as shown in FIG. 1. The DC blocking capacitor in the ring resonator is placed on the other end of the varactor position to make the overall filter structure symmetric. It is possible to use a conventional quarter-wave length long high impedance line with a quarter-wave length long radial stub for the biasing circuit. But it occupies a good amount of space, which makes the filter larger. The aforementioned Parascan® varactors developed by Paratek Microwave Inc., the assignee of the present invention, draw current in the range of few microamperes. The voltage drop in the resistor is almost negligible. Therefore, the biasing circuit for the varactors consists of short section of high impedance line and high resistor. The comb-ring type filter resonator is shown generally in FIG. 1 as 100 and now described more specifically includes a first DC bias 105, a second DC bias 110 and third DC bias 130. DC ground is provided at 115 and 185 with vias to ground shown at 125, 150, 170 and 190. Resisters are integrated into the comb-ring type filter 100 at 120, 142, 175 and 180. The combline resonators used in the present invention are illustrated at 135 and 155 with input line 137 associated with combline resonator 135 and output line 159 integrated with combline resonator 155. Coupling input line 137 and output line 159 is input-output coupling line 195. Ring resonator is depicted at 165 with DC blocking capacitor 160 and varactor 157 associated therewith. Another DC blocking capacitor is shown at 122 and 162 and additional varactors depicted at 140 and 145.

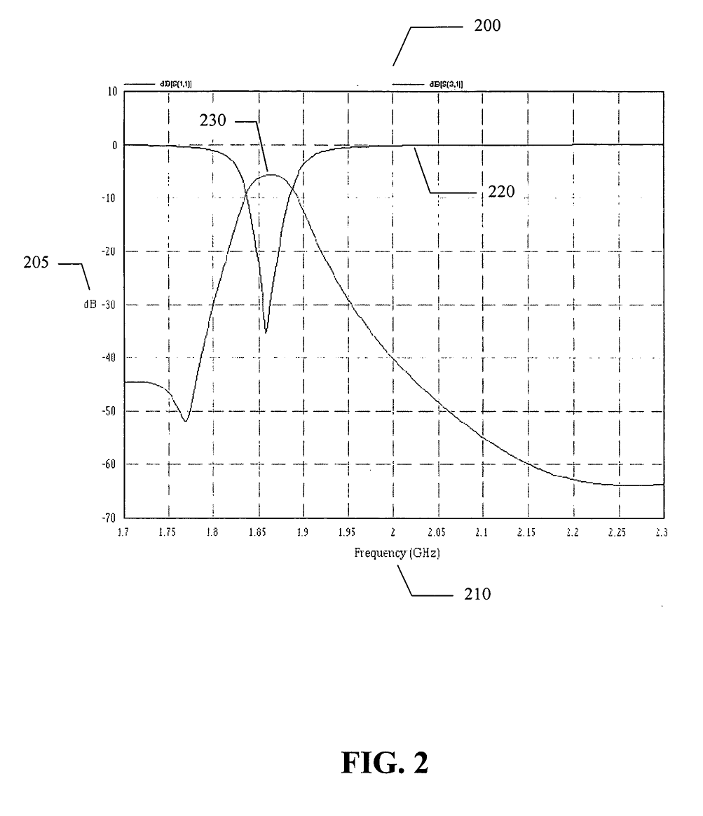

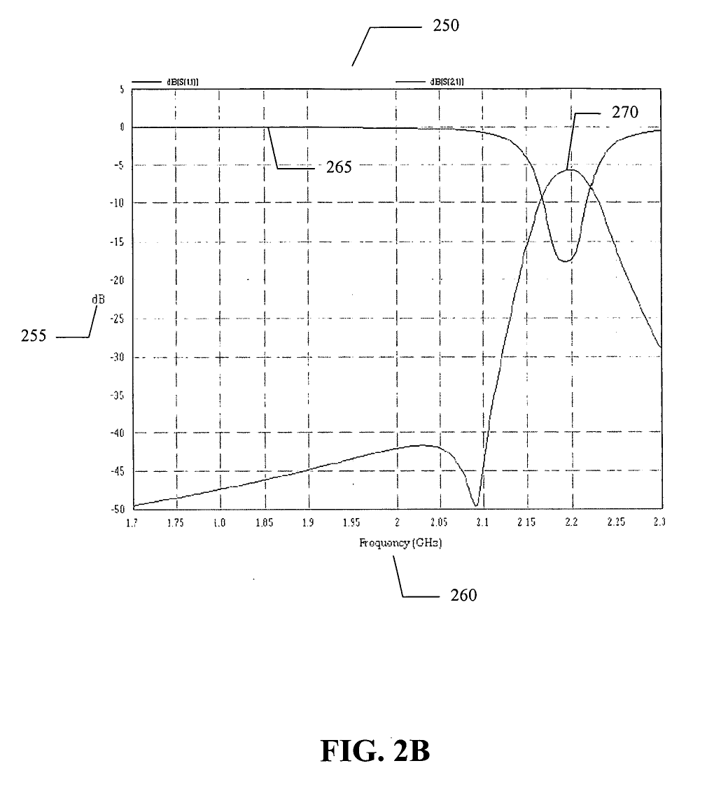

The tuning characteristics of the filter is shown in FIGS. 2A and 2B. FIG. 2, shown generally as 200, graphically shows, in dB 205 vs. Frequency in GHz 210, insertion loss 230 and return loss 220. FIG. 2B, shown generally as 250, graphically shows, in dB 255 vs. Frequency in GHz 260 the return loss 265 and insertion loss 270.

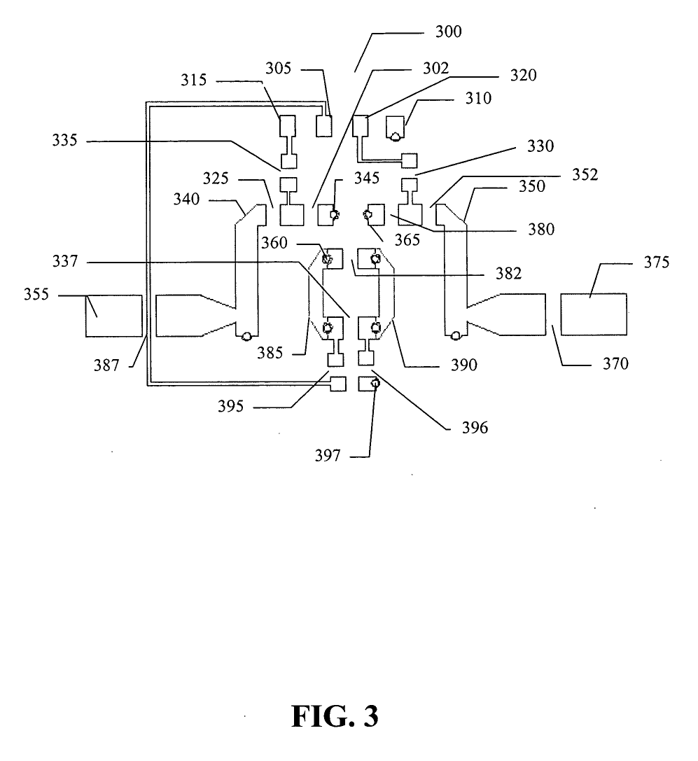

The filter layout for the second embodiment is shown in FIG. 3. The cross coupling required to create transmission zeros is realized by placing the ring resonator in a different layer relative to the combline resonators. The cross coupling depends on the relative position of the resonator. But to mount the tunable component and the DC blocking capacitor, that portion of the ring resonator is brought to the top layer. The comb-ring type filter of this embodiment of the present invention is shown generally in FIG. 3 as 300 and includes a first DC bias 315, a second DC bias 305 and third DC bias 320. DC ground is provided at 310 and 397 with vias to ground shown at 345, 360 and 365. Resisters are integrated into the comb-ring type filter 100 at 330, 335, 395 and 396. The combline resonators used in the present invention are illustrated at 340 and 350 with input line 355 associated with combline resonator 340 and output line 375 integrated with combline resonator 350. The section of the ring resonator that is in the lower layer is depicted at 385 and 390 with DC blocking capacitor 337 and varactor 382 associated therewith. Additional DC blocking capacitors are shown at 302 and 380, as well as a DC blocking capacitor 387 associated with the input line 355 of combline resonator 340 and DC blocking capacitor 370 associated with the output line 375 of combline resonator 350. Additional varactors are depicted at 325 and 352.

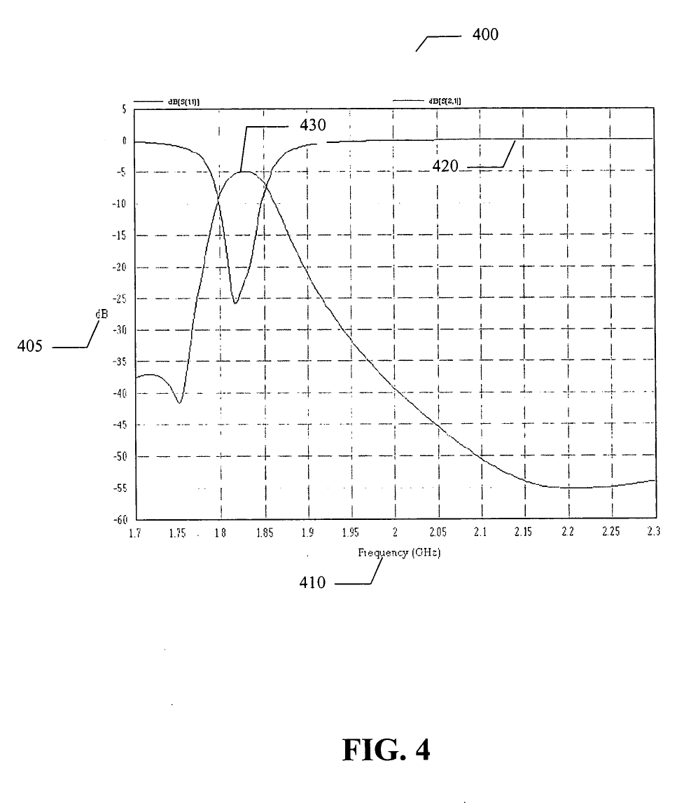

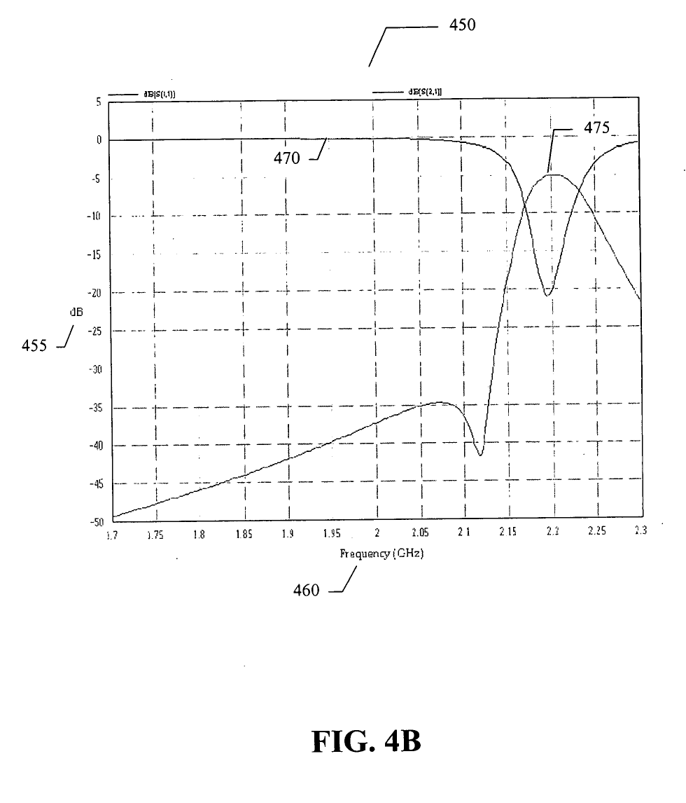

The tuning characteristics of the filter of the second embodiment is shown in FIGS. 4A and 4B. FIG. 4, shown generally as 400, graphically shows, in dB 405 vs. Frequency in GHz 410, insertion loss 430 and return loss 420. FIG. 4B, shown generally as 450, graphically shows, in dB 455 vs. Frequency in GHz 460 the return loss 470 and insertion loss 465.

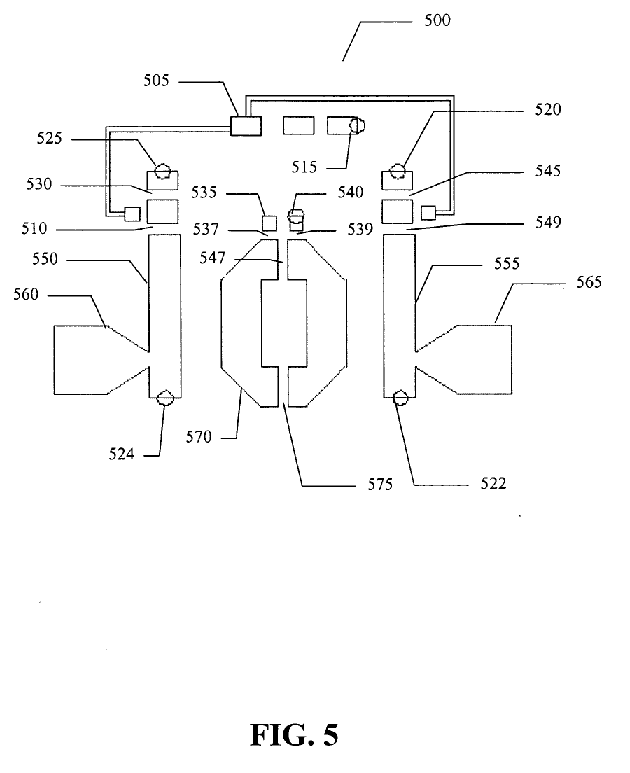

The filter layout for the third embodiment is shown in FIG. 5. The cross coupling is realized by keeping two comb line resonators straight and by placing the ring resonator in a unique way. Utilizing this unique placement it is possible to have enough cross coupling between the two end resonators to create a transmission zero. The transmission zero position can be adjusted using relative positions of the resonators as well as by using different thickness of the substrate supporting the resonators. The cross coupling depends on the relative position of the resonator. The comb-ring type filter of this embodiment of the present invention is shown generally in FIG. 5 as 500 and includes a first DC bias 505 and a second DC bias 535. DC ground is provided at 540 with vias to ground shown at 515, 520, 522, 524 and 525. Resisters are integrated into the comb-ring type filter 500 at 537 and 539. The combline resonators used in the present invention are illustrated at 550 and 555 with input line 560 associated with combline resonator 550 and output line 565 integrated with combline resonator 555. The ring resonator is depicted at 570 with DC blocking capacitor 547 and varactor 575 associated therewith. Additional varactors are depicted at 510 and 549 and additional DC blocking capacitors are shown at 530 and 545.

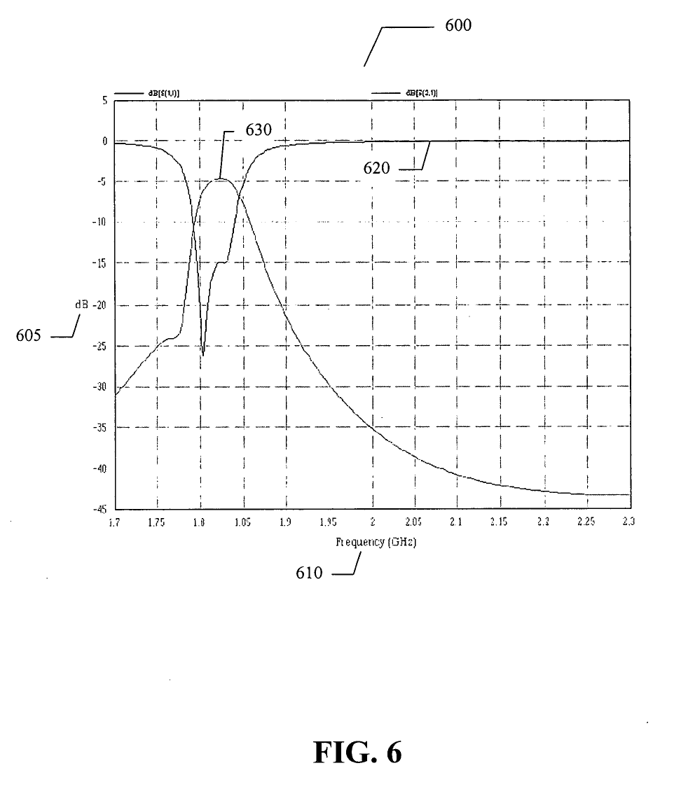

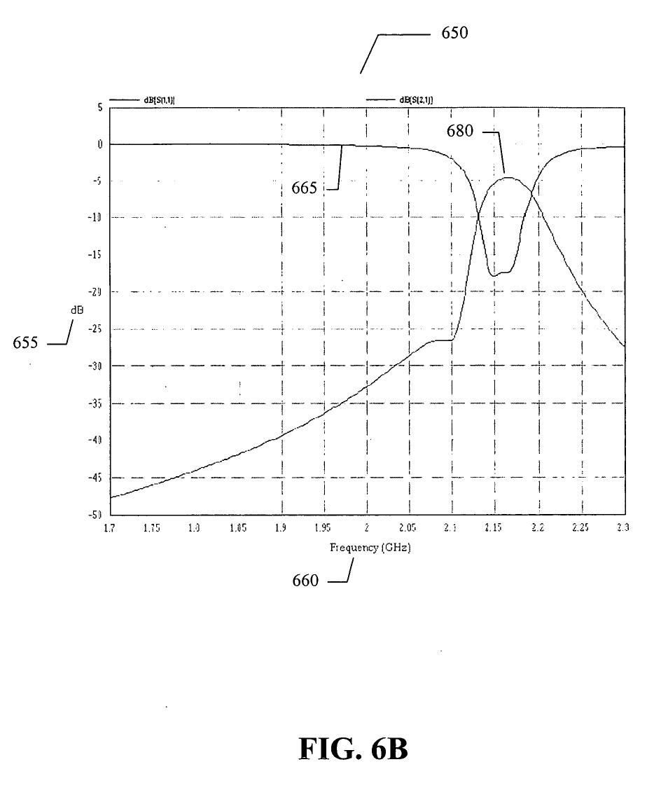

The tuning characteristics of the filter is shown in FIGS. 6A and 6B. FIG. 6, shown generally as 600, graphically shows, in dB 605 vs. Frequency in GHz 610, insertion loss 630 and return loss 620. FIG. 6B, shown generally as 650, graphically shows, in dB 655 vs. Frequency in GHz 660 the return loss 665 and insertion loss 680.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

What is claimed is:

1. A voltage-controlled tunable comb-ring type filter comprising:
a first resonator;
a second resonator coupled to said first resonator;
a third resonator coupled to said second resonator and cross coupled to said first resonator.

2. The voltage-controlled tunable comb-ring type filter of claim 1, wherein said first resonator is a combline type resonator.

3. The voltage-controlled tunable comb-ring type filter of claim 1, wherein said second resonator is a ring type resonator.

4. The voltage-controlled tunable comb-ring type filter of claim 1, wherein said third resonator is a combline type resonator.

5. The voltage-controlled tunable comb-ring type filter of claim 1, further comprising an input transmission line connected with said first resonator.

6. The voltage-controlled tunable comb-ring type filter of claim 1, further comprising an output transmission line connected with said third resonator.

7. The voltage-controlled tunable comb-ring type filter of claim 1, wherein the cross coupling mechanism between said first resonator and said third resonator is through a transmission line shorted on both ends.

8. The voltage-controlled tunable comb-ring type filter of claim 1, wherein the means for cross coupling said third resonator to said first resonator is by placing said second resonator in a different layer.

9. The voltage-controlled tunable comb-ring type filter of claim 1, wherein the means for cross coupling said third resonator to said first resonator is by keeping said first resonator and said third resonator relatively straight and placing the second resonator such that cross coupling occurs between said first resonator and said second resonator by virtue of the proximity of all three resonators to each other.

10. The voltage-controlled tunable comb-ring type filter of claim 1, wherein at least one of said resonators includes at least one variable capacitor.

11. The voltage-controlled tunable comb-ring type filter of claim 1, wherein each of said first, second and third resonators includes at least one variable capacitor.

12. The voltage-controlled tunable comb-ring type filter of claim 10, further comprising biasing lines associated with said variable capacitor to provide bias to said variable capacitors.

13. The voltage-controlled tunable comb-ring type filter of claim 12, wherein said biasing lines include four resistors to block any RF leakage into said DC biasing lines.

14. The voltage-controlled tunable comb-ring type filter of claim 1, wherein any or all of said resonators can be implemented in a microstrip or stripline form.

15. The voltage-controlled tunable comb-ring type filter of claim 1, wherein any or all of said resonators can be bent towards each other to reduce the size of said filter.

16. The voltage-controlled tunable comb-ring type filter of claim 1, wherein in any or all of said resonators DC blocking capacitor are used at the end of said any or all of said resonators in order to bias any or all of said resonators.

17. The voltage-controlled tunable comb-ring type filter of claim 10, further comprising a ring resonator circuit with a DC blocking capacitor at the opposite end of said variable capacitor position in order to make the whole structure symmetric.

18. The voltage-controlled tunable comb-ring type filter of claim 10, wherein said variable capacitor is a tunable dielectric capacitor.

19. The voltage-controlled tunable comb-ring type filter of claim 18, wherein said tunable dielectric capacitor includes a substrate having a low dielectric constant with planar surfaces.

20. The voltage-controlled tunable comb-ring type filter of claim 19, further comprising a tunable dielectric film on said substrate made from a low loss tunable dielectric material.

22. The voltage-controlled tunable comb-ring type filter of claim 1, further comprising a metallic electrode with predetermined length, width, and gap distance associated with at least one resonator.

23. The voltage-controlled tunable comb-ring type filter of claim 21, further comprising a low loss isolation material used to isolate an outer bias metallic contact and the metallic electrode on said tunable dielectric material.

24. The voltage-controlled tunable comb-ring type filter of claim 10, wherein the center frequency of the filter is tuned by changing the varactor capacitance controlled by changing the voltage applied to said varactor.

25. The voltage-controlled tunable comb-ring type filter of claim 10, wherein said variable capacitor is a tunable MEMS capacitor.

26. The voltage-controlled tunable comb-ring type filter of claim 25, wherein said tunable MEMS capacitor is in a parallel or interdigital plate topology.

27. The voltage-controlled tunable comb-ring type filter of claim 10, wherein said variable capacitor is a tunable semiconductor diode varactor.

28. The voltage-controlled tunable comb-ring type filter of claim 8, further comprising a means of inter-resonator coupling between adjacent and non-adjacent resonators in said filters.

29. A method of filtering signals using a voltage-controlled tunable comb-ring type filter comprising the steps of:
providing a first resonator;
coupling a second resonator to said first resonator;
coupling a third resonator to said second resonator and cross coupling third resonator to said first resonator.

30. The method of filtering signals using a voltage-controlled tunable comb-ring type filter of claim 29, wherein said first resonator is a combline type resonator.

31. The method of filtering signals using a voltage-controlled tunable comb-ring type filter of claim 29, wherein said second resonator is a ring type resonator.

32. The method of filtering signals using a voltage-controlled tunable comb-ring type filter of claim 29, wherein said third resonator is a combline type resonator.

33. The method of filtering signals using a voltage-controlled tunable comb-ring type filter of claim 29, further comprising an input transmission line connected with said first resonator.

34. The method of filtering signals using a voltage-controlled tunable comb-ring type filter of claim 29, further comprising the step of providing an output transmission line connected with said third resonator.

35. The method of filtering signals using a voltage-controlled tunable comb-ring type filter of claim 29, wherein the cross coupling mechanism between said first resonator and said third resonator is through a transmission line shorted on both ends.

36. The method of filtering signals using a voltage-controlled tunable comb-ring type filter of claim 29, wherein the means for cross coupling said third resonator to said first resonator is by placing said second resonator in a different layer.

37. The method of filtering signals using a voltage-controlled tunable comb-ring type filter of claim 29, wherein the means for cross coupling said third resonator to said first resonator is by keeping said first resonator and said third resonator relatively straight and placing the second resonator such that cross coupling occurs between said first resonator and said second resonator by virtue of the proximity of all three resonators to each other.

38. The method of filtering signals using a voltage-controlled tunable comb-ring type filter of claim 29, wherein at least one of said resonators includes at least one variable capacitor.

39. The method of filtering signals using a voltage-controlled tunable comb-ring type filter of claim 29, wherein each of said first, second and third resonators includes at least one variable capacitor.

40. The method of filtering signals using a voltage-controlled tunable comb-ring type filter of claim 29, further comprising the step of providing bias to said variable capacitors by providing biasing lines associated with said variable capacitor.

41. The method of filtering signals using a voltage-controlled tunable comb-ring type filter of claim 29, wherein said biasing lines include four resistors to block any RF leakage into said DC biasing lines.

42. The method of filtering signals using a voltage-controlled tunable comb-ring type filter of claim 29, wherein any or all of said resonators can be implemented in a microstrip or stripline form.

43. The method of filtering signals using a voltage-controlled tunable comb-ring type filter of claim 29, wherein any or all of said resonators can be bent towards each other to reduce the size of said filter.

44. The method of filtering signals using a voltage-controlled tunable comb-ring type filter of claim 29, wherein in any or all of said resonators DC blocking capacitor are used at the end of said any or all of said resonators in order to bias any or all of said resonators.

45. The method of filtering signals using a voltage-controlled tunable comb-ring type filter of claim 38, further comprising the step of providing a ring resonator circuit with a DC blocking capacitor at the opposite end of said variable capacitor position in order to make the whole structure symmetric.

46. The method of filtering signals using a voltage-controlled tunable comb-ring type filter of claim 38, wherein said variable capacitor is a tunable dielectric capacitor.

47. The method of filtering signals using a voltage-controlled tunable comb-ring type filter of claim 46, wherein said tunable dielectric capacitor includes a substrate having a low dielectric constant with planar surfaces.

48. The method of filtering signals using a voltage-controlled tunable comb-ring type filter of claim 47, further comprising the step of providing a tunable dielectric film on said substrate made from a low loss tunable dielectric material.

49. The method of filtering signals using a voltage-controlled tunable comb-ring type filter of claim 29, further comprising a metallic electrode with predetermined length, width, and gap distance associated with at least one resonator.

50. The method of filtering signals using a voltage-controlled tunable comb-ring type filter of claim 48, further comprising the step of providing a low loss isolation material used to isolate an outer bias metallic contact and the metallic electrode on said tunable dielectric material.

51. The method of filtering signals using a voltage-controlled tunable comb-ring type filter of claim 38, wherein the center frequency of the filter is tuned by changing the varactor capacitance controlled by changing the voltage applied to said varactor.

52. The method of filtering signals using a voltage-controlled tunable comb-ring type filter of claim 38, wherein said variable capacitor is a tunable MEMS capacitor.

53. The method of filtering signals using a voltage-controlled tunable comb-ring type filter of claim 52, wherein said tunable MEMS capacitor is in a parallel or interdigital plate topology.

54. The method of filtering signals using a voltage-controlled tunable comb-ring type filter of claim 38, wherein said variable capacitor is a tunable semiconductor diode varactor.

55. The method of filtering signals using a voltage-controlled tunable comb-ring type filter of claim 29, further comprising the step of providing a means of inter-resonator coupling between adjacent and non-adjacent resonators in said filters.

56. A voltage-controlled tunable comb-ring type filter comprising:
a plurality of resonators, said plurality of resonators comprising:
a first of at least two combline type resonators;
a first of at least one ring type resonator coupled to said first of at least two combline type resonator;
a second of said at least two combline type resonator coupled to said first of at least one ring type resonator and cross coupled to said first of at least two combline type resonators;
at least one of said plurality of resonators includes at least one variable capacitor;
an input transmission line connected with at least one of said plurality of resonators;
an output transmission line connected with at least one of said resonators;.

57. The voltage-controlled tunable comb-ring type filter of claim 56, wherein the cross coupling mechanism between said second of said at least two combline type resonators with said first of at least two combline type resonators is through a transmission line shorted on all ends of said at least two combline type resonators.

58. The voltage-controlled tunable comb-ring type filter of claim 57, wherein the means for cross coupling said second of said at least two combline type resonators with said first of at least two combline type resonators is by placing said first of at least one ring type resonator in a different layer.

59. The voltage-controlled tunable comb-ring type filter of claim 57, wherein the means for cross coupling said second of said at least two combline type resonators with said first of at least two combline type resonators is by keeping all of said at least two combline type resonators relatively straight and placing said first of at least one ring type resonator such that cross coupling occurs between said plurality of resonators by virtue of the proximity of all of said plurality of resonators.

60. The voltage-controlled tunable comb-ring type filter of claim 57, further comprising biasing lines associated with said variable capacitor to provide bias to said variable capacitors.

61. The voltage-controlled tunable comb-ring type filter of claim 60, wherein said biasing lines include four resistors to block any RF leakage into said DC biasing lines.

62. The voltage-controlled tunable comb-ring type filter of claim 57, wherein any or all of said resonators can be implemented in a microstrip or stripline form.

63. The voltage-controlled tunable comb-ring type filter of claim 57, wherein any or all of said resonators can be bent towards each other to reduce the size of said filter.

64. The voltage-controlled tunable comb-ring type filter of claim 57, wherein in any or all of said resonators DC blocking capacitor are used at the end of said any or all of said resonators in order to bias any or all of said resonators.

65. The voltage-controlled tunable comb-ring type filter of claim 57, further comprising a ring resonator circuit with a DC blocking capacitor at the opposite end of said variable capacitor position in order to make the whole structure symmetric.

66. The voltage-controlled tunable comb-ring type filter of claim 57, wherein said variable capacitor is a tunable dielectric capacitor.

67. The voltage-controlled tunable comb-ring type filter of claim 66, wherein said tunable dielectric capacitor includes a substrate having a low dielectric constant with planar surfaces.

68. The voltage-controlled tunable comb-ring type filter of claim 67, further comprising a tunable dielectric film on said substrate made from a low loss tunable dielectric material.

69. The voltage-controlled tunable comb-ring type filter of claim 57, further comprising a metallic electrode with predetermined length, width, and gap distance associated with at least one resonator.

70. The voltage-controlled tunable comb-ring type filter of claim 66, wherein the center frequency of the filter is tuned by changing the varactor capacitance controlled by changing the voltage applied to said varactor.

71. The voltage-controlled tunable comb-ring type filter of claim 57, wherein said variable capacitor is a tunable MEMS capacitor.
